(19) United States
(12) Patent Application Publication
(10) Pub. No.: US 2018/0188940 A1
(43) Pub. Date: Jul. 5, 2018

(54) Control input method and device for executing the same

(71) Applicant: Motorious Entertainment Oy, Helsinki (FI)

(72) Inventor: Jari Pauna, Tampere (FI)

(73) Assignee: Motorious Entertainment Oy, Helsinki (FI)

(21) Appl. No.: 15/396,706

(22) Filed: Jan. 2, 2017

(51) Int. Cl. G06F 3/0488; G06F 3/0482; G06F 3/0484; A63F 13/2145

(52) U.S. Cl. CPC G06F 3/04883; G06F 3/0482; G06F 3/04817; A63F 13/2145; G06F 3/04845

(57) ABSTRACT

Electronic device (200) comprising a touchscreen (242, 306), data storage (304) and a processor (302) operatively connected to the touchscreen and the data storage, configured to display a first on-screen area (242A) for accommodating one or more user-controllable graphical objects (241), such as game characters, further to display, simultaneously with the first on-screen area, a second on-screen area (242B) preferably substantially adjacent to the first on-screen area, said second on-screen area being provided with two-dimensional structure (243) of a plurality of graphical control elements (244), which are user-selectable by touch, to detect a touch action-based user selection of multiple control elements of said plurality, wherein the selected control elements define a continuous pattern in vertical, horizontal and/or diagonal direction within the structure, and further wherein the touch action extends over at least two control elements depicted in the second on-screen area at least one of which being a member of the pattern of the selected elements, to determine a control action for at least one user-controllable object in the first on-screen area responsive to the detected user selection and stored control data associating a number of selections of multiple control elements with control actions including an association of the detected user selection with the determined control action, and finally to execute the control action regarding said least one object in the first on-screen area according to the determination.

### FIELD OF THE INVENTION

Generally the present invention relates to electronic devices and related input methods for controlling the associated functionalities. Particularly, however not exclusively, the present invention pertains to control input arrangements involving a touch surface of a touchscreen, capable of receiving touch-based user input based on detecting the touch and related touch location upon a graphical display view.

### BACKGROUND

Generally there exists a great variety of different control input methods and technologies for electronic devices such as desktop computers, laptops, tablets, smartphones, multimedia devices and many other appliances, which may have been intended for personal or joint use both alike.

The motivation behind gathering and interpreting (control) input from a user may be as diverse as the related use contexts. In a multi-purpose device such as a smartphone or a tablet type computer an application running thereon, with reference to e.g. some utility or game application, may contain a user-controllable feature such as a messaging window or a movable game character, respectively. Some applications may require using rather limited control input only, having regard to e.g. a torch type application wherein binary type on/off input mechanism may suffice just fine and be implemented by means of simple physical or virtual two-position switch, whereas in some other contexts the overall number of user controlled features may rise to hundreds or even more considering e.g. different professional design or control software. Optimal way of providing control input may thus vary, besides between different devices, also between applications executed by a single device.

In many use scenarios, at least one feasible if not optimum modality of user input includes the aforementioned touchscreen. Touch input is provided by applying a fingertip or a specific stylus upon a touch-sensitive display screen, whereupon the touch location and a number of optional related parameters, such as pressure, are detected and converted into representative control signals. In addition to tracking discrete input, touch may be tracked substantially continuously so that swipes and other gestures involving a detectable trajectory instead of a single touch location can be distinguished from more isolated touches. It is further possible to trace touch patterns involving multiple subsequent touches upon the touch display at one or more locations. Yet, multi-touch detection is based on simultaneous tracking of several contact points on the touch surface.

Nevertheless, in applications where versatile touch-based control input for potentially numerous, complex responses is to be repeatedly dynamically provided via a touchscreen, the contemporary solutions appear to provide in many cases rather sub-optimum performance.

The currently available touch-based UIs (user interface) are often poor in terms of layout and design such as the appearance of shown, user-selectable GUI (Graphical UI) elements with particular reference to input controls. The overall number of required elements to be illustrated to a user for activation purposes, each element being potentially associated with a function and thus a response of its own, may be so great that their size has to be scaled down to a level where their necessary initial visual inspection, subsequent adoption and ultimately selection becomes rather tricky using fingertips and even conventional styluses. Quite often a need to use a stylus is considered undesirable anyway, because the availability of the stylus cannot be always guaranteed even if it could be carried along in connection with the target device e.g. in the same cover or carrying bag.

As the size of individual control elements goes down, the associativity of the elements with the underlying functionalities suffers, because there may be no sufficient space available anymore for unambiguously indicating the functionalities graphically in the concerned element e.g. via an icon. Accordingly, use experience may degrade both due to fatigue and uncertainty arising from the obscurity of the shown input control symbols in addition to direct physical difficulties experienced in pointing them with necessary accuracy. The overly-reduced dimensions of the control elements obviously cause further problems e.g. in the use of colors, textures, typography and other visually potentially distinctive features, which could be otherwise cleverly intended for emphasizing, de-emphasizing or characterizing the functionalities underlying the elements. Finally, inferior UIs add latency to the overall use experience as the users are basically forced to spend more time with the offered, sadly flawed interaction mechanism for providing control input in contrast to options with better usability.

### SUMMARY

The objective of the present invention is to at least alleviate one or more of the above drawbacks associated with the existing solutions in the context of electronic devices and related graphical, touch-based user interfaces as well as associated control methods.

The objective is achieved with various embodiments of an electronic device and related control method in accordance with the present invention.

According to one embodiment of the present invention, an electronic device comprising a touchscreen, data storage and a processor operatively connected to the touchscreen and the data storage, is configured to:

display a first on-screen area for accommodating one or more user-controllable graphical objects, such as game characters or other graphical objects,

display, simultaneously with the first on-screen area, a second on-screen area preferably substantially adjacent to, optionally below or above, the first on-screen area, said second on-screen area being provided with a preferably symmetrical at least two-dimensional structure, such as a matrix, of a plurality of graphical control elements, optionally icons, which are user-selectable by touch,

detect a touch action-based, preferably swipe action based, user selection of multiple, preferably at least three, control elements of said plurality, wherein the selected control elements define a continuous pattern in vertical, horizontal and/or diagonal direction within the structure, and further wherein the touch action extends over at least two control elements depicted in the second on-screen area at least one of which being a member of the pattern of the selected elements,

determine a control action for at least one user-controllable object in the first on-screen area responsive to the detected user selection and stored control data associating a number of selections of multiple control elements with control actions including an association of the detected user selection with the determined control action, and

execute the control action regarding said least one object in the first on-screen area according to the determination.

In one other embodiment, a method for receiving control input at an electronic device comprising a touchscreen, data storage and a processor operatively connected to the data storage and the touchscreen, comprises:

displaying a first on-screen area for accommodating one or more user-controllable graphical objects, such as game characters or other graphical objects,

displaying, simultaneously with the first on-screen area, a second on-screen area preferably substantially adjacent to, optionally below or above, the first on-screen area, said second on-screen area being provided with a preferably symmetrical at least two-dimensional structure, such as a matrix, of a plurality of graphical control elements, optionally icons, which are user-selectable by touch,

detecting a touch action-based, preferably swipe action based, user selection of multiple, preferably at least three, control elements of said plurality, wherein the selected elements define a continuous pattern in vertical, horizontal and/or diagonal direction within the structure, and further wherein the touch action extends over at least two control elements depicted in the second on-screen area at least one of which being a member of the pattern of the selected elements,

determining a control action for at least one user-controllable object in the first on-screen area responsive to the detected user selection and stored control data associating a number of selections of multiple control elements with control actions including an association of the detected user selection with the determined control action, and

executing the control action regarding said least one object in the first on-screen area according to the determination.

The utility of the present invention arises from a plurality of issues depending on the embodiment. First of all, the exploited general modality of user input, with reference to touchscreens, is typically very easy to adopt and understand as well as rapid to use by a great majority of users. Secondly, a touchscreen area may be dynamically provided with reasonably dimensioned (basically large enough to facilitate their selection and visual identification) control elements organized in e.g. dynamically updatable structure such as two-dimensional matrix structure, wherein a user selection of multiple control elements defining a continuous pattern of elements within the structure may be converted into a great variety of different control responses depending e.g. on the type of the elements included in the pattern, the overall shape of the selection and/or the number of elements in the selection, while the overall number of mutually different distinguishable control elements may be kept relatively modest in favor of the overall intelligibility of the UI view and related possible control activities.

Yet, in various embodiments the shown control elements are indeed preferably configured by the executing electronic device so as to indicate graphically, e.g. via characterizing shape, symbol, icon, color, graphical pattern, number, and/or text, the nature of the associated control action arising from them if included in the user selection. For example, movement of the graphical object to the left could be indicated through rendering a left arrow in the element.

The associations between user selections of shown control elements and resulting control actions, i.e. responses to user input, are preferably substantially deterministic and pre-defined, and not e.g. randomly and dynamically decided after detecting a user selection of multiple adjacent elements. Accordingly, a user can really predict and comprehend beforehand what kind of a control action of a graphical object is to be executed responsive to making some particular user selection of control element, i.e. the control action response is preferably not random or pseudo-random from the standpoint of a user perception either. Thus the solution may find use in many applications requiring precise, deterministic control such as professional graphical design or engineering applications in addition to entertainment such as games. Nonetheless, e.g. many action games where a game character or object is to be deterministically controlled by user input benefit greatly from the embodiments of the present solution.

Further utilities of various embodiments of the present invention become apparent to a person skilled in the art based on the following detailed description.

Different considerations presented herein concerning the various embodiments of the device may be flexibly applied to the embodiments of the method mutatis mutandis, and vice versa, as being appreciated by a skilled person.

The expression “a number of” may herein refer to any positive integer starting from one (1).

The expression “a plurality of” may refer to any positive integer starting from two (2), respectively.

The terms “first” and “second” are herein used to distinguish one element from other element, and not to specially prioritize or order them, if not otherwise explicitly stated.

Different embodiments of the present invention are disclosed in the attached dependent claims.

### BRIEF DESCRIPTION OF THE DRAWINGS

Next the present invention will be described in greater detail with reference to the accompanying drawings, in which:

FIG. 1 is a flow diagram in accordance with an embodiment of a method of the present invention.

FIG. 2 illustrates potential use context of the present invention and an embodiment of a device according to the present invention.

FIG. 3 is block diagram of an embodiment of a device according to the present invention.

FIGS. 4A-4H depict few embodiments of applicable control element layouts and possible but merely exemplary user selections of multiple control elements applicable therein for triggering associated control actions in connection with the present invention.

FIG. 5 still depicts further embodiments of potential control element layouts, related user selections and control actions having regard to a graphical object such as game character or other graphical feature controlled.

### DETAILED DESCRIPTION

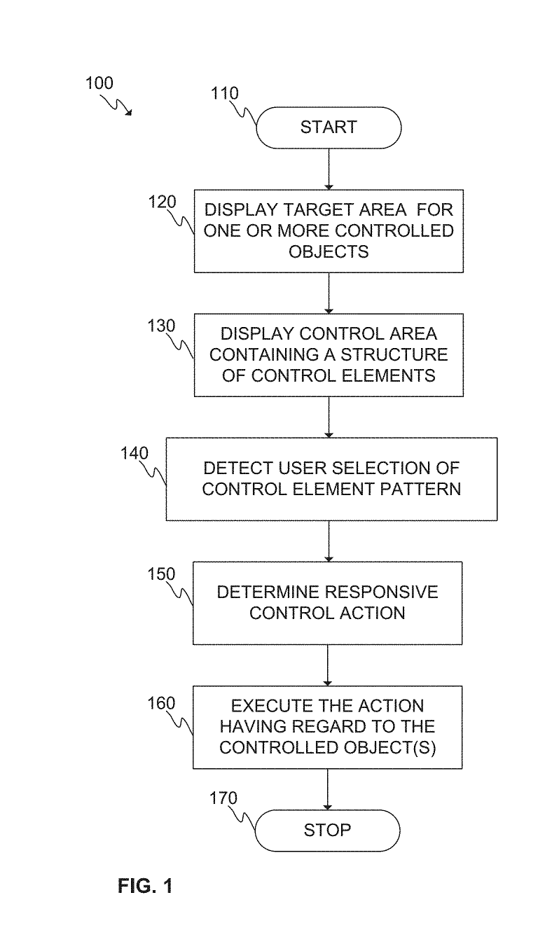

FIG. 1 is a flow diagram disclosing an embodiment of a method 100 in accordance with the present invention.

At the beginning of the method, a number of start-up phase activities 110 may be executed. A data repository (memory) of an electronic device, such as a smartphone or a tablet, may be provided with e.g. downloadable software such as a game application or utility software containing control data and control logic for implementing an embodiment of a control input method described herein together with device hardware such as processor for executing the associated program code and at least one touchscreen for rendering the control layout encompassing a plurality of graphical control elements and other application data such as the controlled graphical object, optionally a game character, to a user.

At 120, a first (on-)screen area configured to accommodate one or more user-controllable graphical objects is displayed, i.e. rendered visible to a user.

In some embodiments, the first screen area may occupy only a portion, e.g. top, bottom, left, right, or a central portion, of a larger display area defined by a single, touch-sensitive display of the electronic device. A second screen area may be then established from a remaining portion of the larger display area of the single display.

In some other embodiments, the first screen area may or may not occupy substantially the whole display area of a first, optionally touch-sensitive, display, as there still is a second, touch-sensitive, display for rendering a second (on-)screen area.

At 130, the second screen area is shown with e.g. a matrix type structure, or ‘control layout’, incorporating and exhibiting a plurality of graphical control elements.

The control elements may bear mutually similar or different general shape (e.g. angular such as rectangular or rounded shape). As they may be associated with mutually different implications in a resulting control action, i.e. they may be of different type, an implication associated with a control element may be graphically indicated in the control element by means of a user perceivable feature such as number, symbol, pattern, text, color, animation effect, shading, size, picture, background, and/or overall shape of the element.

At 140, a user selection of multiple graphical control elements preferably defining a continuous pattern within the structure is detected. The pattern may be of substantially line type or exhibit a more complex shape with e.g. piece-wise linear portions such as orthogonal portion(s) and/or diagonal portion(s), wherein an orthogonal portion refers to an essentially vertical or horizontal portion.

The user selects the multiple control elements utilizing e.g. one technique selected from the group consisting of:
simultaneous multi-selection input measure (e.g. several fingers simultaneously contacting the touch-sensitive surface of the display upon the elements selected);
sequential, essentially swipe type selection measure (finger or stylus defining a continuous trajectory upon the structure, extending over the elements selected); and
a specific swap action, wherein the user marks by e.g. a simultaneous multi-selection or swipe, two, preferably but not necessarily adjacent, elements to be at least temporally mutually swapped in terms of location to establish, again at least temporarily, the user selection for triggering an associated control action. The swap action differs from e.g. straightforward simultaneous multi-selection or swipe type selection of elements in a sense that the swap as such does not have to address all members of the resulting selection. It may only address a single selected member that, due to the swap, implicitly indicates to the device the remaining selections at least one of which is then adjacent to the swapped member in its new (at least temporary) location after the swap. Potential swap mechanics are also contemplated hereinafter.

At 150, a control action relating to the user selection is determined. Preferably, the memory of the executing device has been provided with control data that associates a number of, typically a plurality of, user selections of multiple control elements with related control actions, i.e. control responses.

In various embodiments, the control action may depend e.g. on at least one feature of the user selection selected from the group consisting of: number of control elements included, number of identical control elements included, shape of the selection (pattern), and type of the control elements included.

The aforementioned and already briefly discussed type of the control element refers to the nature of the contribution (implication), or ‘partial effect’, the control element may have in the resulting control action. For example, if one control element is associated with left turn in a car racing game (preferably the element also indicates such contribution or ‘partial effect’ of the element in the control action by suitable visual indication such as a left arrow), it may cause the controlled object to indeed turn left when the control command is executed.

In some embodiments, a presence of multiple control elements of the same type in the user selection converts into an increase in the magnitude of a resulting control action associated with such selection, optionally movement of a rendered graphical object. For example, one control element associated with left turn and preferably left arrow as a graphical indicator, may cause a controlled vehicle to turn or rotate left by some fixed amount (e.g. 20 degrees), whereas one additional similar element in the user selection may double the degrees rotated.

In some embodiments, a minimum number of similar control elements, e.g. two, three or four elements, may be required in the selection to enable the associated control action to occur in the first place (e.g. three ‘left turn’ related elements required in the selection to cause the controlled vehicle to turn left at all).

At 160, the control action is executed. In some embodiments as being alluded to hereinbefore, the control action may comprise or be constructed based on several sub-actions or implications of the individual control elements of the user selection.

At least one control action associated with a user selection of multiple control elements defining a pattern may thus be, by way of example only, be selected from the group consisting of: movement of a user-controllable graphical object, orthogonal movement of a user-controllable graphical object, vertical movement of a user-controllable graphical object, horizontal movement of a user-controllable graphical object, movement of a user-controllable graphical object where the amount of movement depends on the number of movement-associated elements in the user selection, acceleration or deceleration of a controllable graphical object, increase in the size or zooming in a graphical object, decrease in the size or zooming out a graphical object, deletion of a feature of a graphical object, addition of a feature in a graphical object, change of a color or a graphical pattern of a graphical object, making and rendering a copy of a graphical object, back and forth type movement such as jump of a graphical object, emission of a feature such as a projectile from a graphical object, and rotation of a graphical object.

Detection of a user selection and/or execution of an associated control action may be indicated to a user, besides through controlling the graphical object, by visually highlighting the pattern underlying the selection. E.g. a connecting element such as line may be rendered between and/or upon the elements of the selection, or some other visual feature such as common graphical effect (e.g. color or graphical/color animation) may be targeted to the elements.

Additionally or alternatively, the touch action of the user may be itself visually highlighted. For example, in the case of the aforementioned swap, the touch action may partially target different elements than the resulting selected ones, whereupon the action may be separately indicated to user with some common feature, e.g. line or color effect, extending over the concerned such as the swapped elements.

Following the touch action of the user to define the user selection and optionally also after the determination and further optionally execution of the associated control action, at least one restoring or readjusting type action relative to the structure of selectable graphical control elements may be executed.

For example, the executing device may be configured to render at least the control elements of the user selection and/or touch action (one may recall these are not necessarily always identical with reference to e.g. the ‘swap’) in their original position prior to the touch action, delete the control elements of the user selection from the second on-screen area, and/or replace the control elements of the user selection from the second on-screen area with other control elements, the other control elements being either new control elements or existing adjacent control elements that are shifted to the locations of the control elements of the user selection optionally in orthogonal such as vertical or particularly top-to-bottom direction preferably so that the remaining elements behind the originally shifted ones are also shifted to the spaces left empty and further preferably so that the resulting empty border areas are introduced with new control elements.

At 170, method execution is ended. In practical circumstances, the execution of method items 120-160 may be basically repeatedly executed as readily understood by a person skilled in the art as the controlled graphical object(s) may require prolonged, regular or intermittent, control, etc.

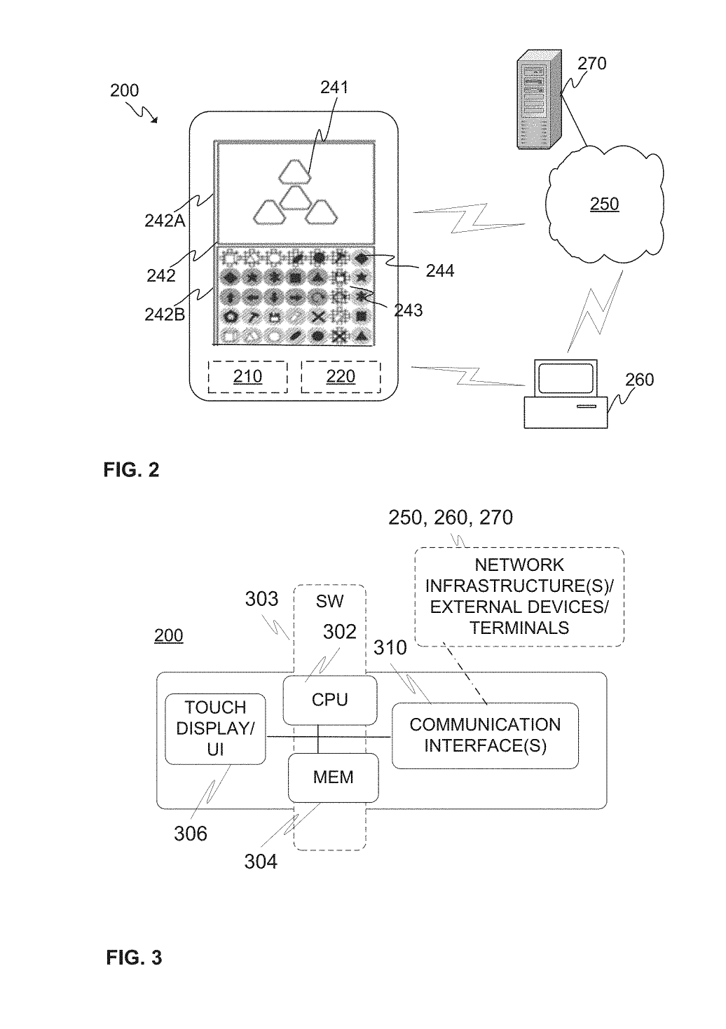

FIG. 2 illustrates potential use context of the present invention and an embodiment of an electronic device 200 configured to execute an embodiment of a method according to the present invention.

Depending on the embodiment, the device 200 may comprise at least one element selected from the group consisting of: mobile terminal, cellular terminal, smartphone, tablet, phablet, desktop computer, laptop computer, wearable computer, wristop computer, in-vehicle multimedia device, game console, multimedia player, and television.

The device 200 may comprise a housing of e.g. plastic, rubber and/or metal, which accommodates various components of the device including at least one touchscreen 242 (touch-sensitive display) for establishing first 242A and second 242B on-screen areas for controlled object(s) 241 and a control layout 243 of control element(s) 244, respectively, possible communication interface(s) that may be wireless and/or wired, and potential additional UI features such as a number of buttons, touch pads, speakers, microphones, etc. indicated in the figure by items 210 and 220.

The controlled objects 241 and related touch-based control mechanisms may relate to a native application running in the terminal or e.g. a browser-executed (e.g. HTML5, hypertext mark-up language) application possibly involving communication with remote element(s) such as a number of network servers.

The device 200 may indeed be connectable to a communications network 250 such as a cellular network, LAN network (local area network) and/or e.g. the Internet via which different remote elements 270 such as servers may be accessed or reached.

Alternatively, an external device 260 such as a computer device may be operatively coupled to the device 200 directly without intermediate devices or networks in between.

For various communication needs, the device 200 may comprise e.g. a longer range cellular interface or a shorter range wired (e.g. USB (universal serial bus) or Ethernet) or wireless interface, e.g. WLAN (wireless local area network), NFC (near-field communication) or Bluetooth™-based interface.

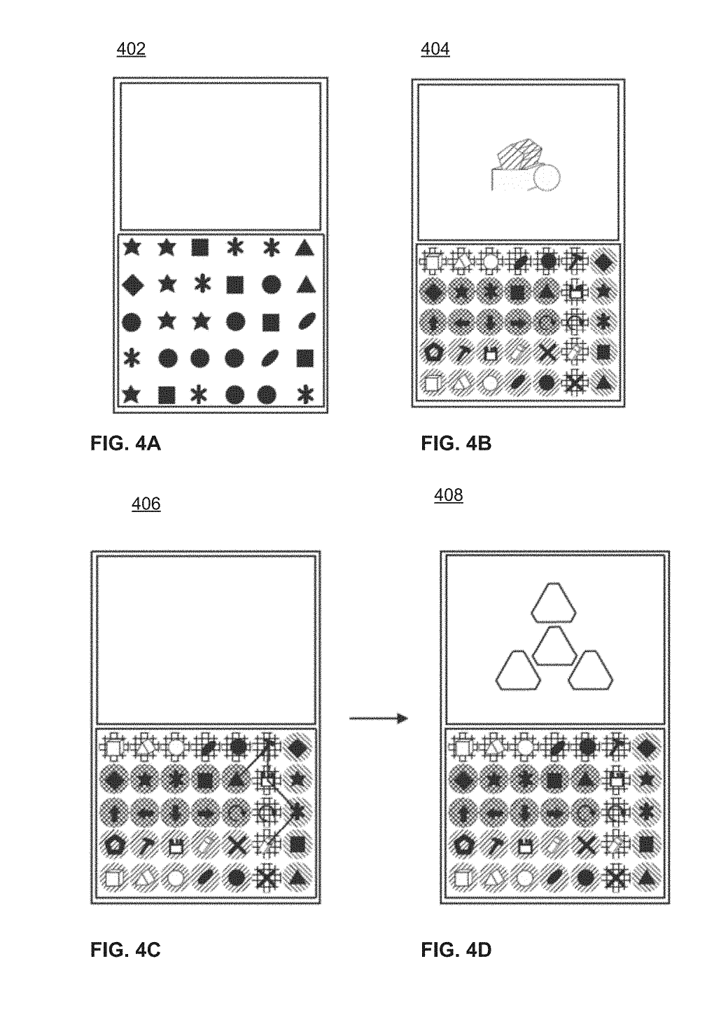

In FIG. 3, a high-level block diagram of an embodiment of the electronic device in accordance with the present invention is explicitly shown with reference to at least one processing device or simply a ‘processor’ 302, such as a microprocessor, signal processor, or a microcontroller, and data storage (memory) 304 such as a number of memory chips optionally integrated with the processing device 302. Touchscreen and potential further UI features (e.g. additional (touch)screen, buttons, microphone, speaker, vibration motor or other vibration element, touchpad, etc.) are shown at 306 whereas communication interface(s) are represented by item 310. In practice, the storage 304 of the device 200 may be loaded with processor-executable instructions in a form of e.g. application or other software 303 that causes the processor 302 to execute an embodiment of a method in accordance with the present invention through controlling the necessary remaining features such as the touchscreen 306 of the device 200 in a manner stipulated by the method. Yet, the storage 304 preferably stores control data that associates a certain user selection of graphical control elements with a certain control action to be executed.

Selected features of the device 200 such as the (touch)screen 306 may be integral with the remaining device 200 or separate, or at least removable, therefrom. In some embodiments, some elements of the device 200 may be physically even farther away from a UI part or client terminal part of the solution with reference to e.g. network-operable servers taking care of at least some processing required to implement an embodiment of the method generally suggested herein. Whether in this case the distributed device implementing the method is actually considered a system of multiple devices instead, is basically a matter of taste only.

The software 303 for controlling the functioning of the device 200 via the at least one processor 302 may be embodied in non-transitory carrier medium such as a memory card, magnetic disc or optical medium, or transferred as a wired or wireless signal over an applicable transitory carrier medium such as air. The software 303 may be provided as a computer program product.

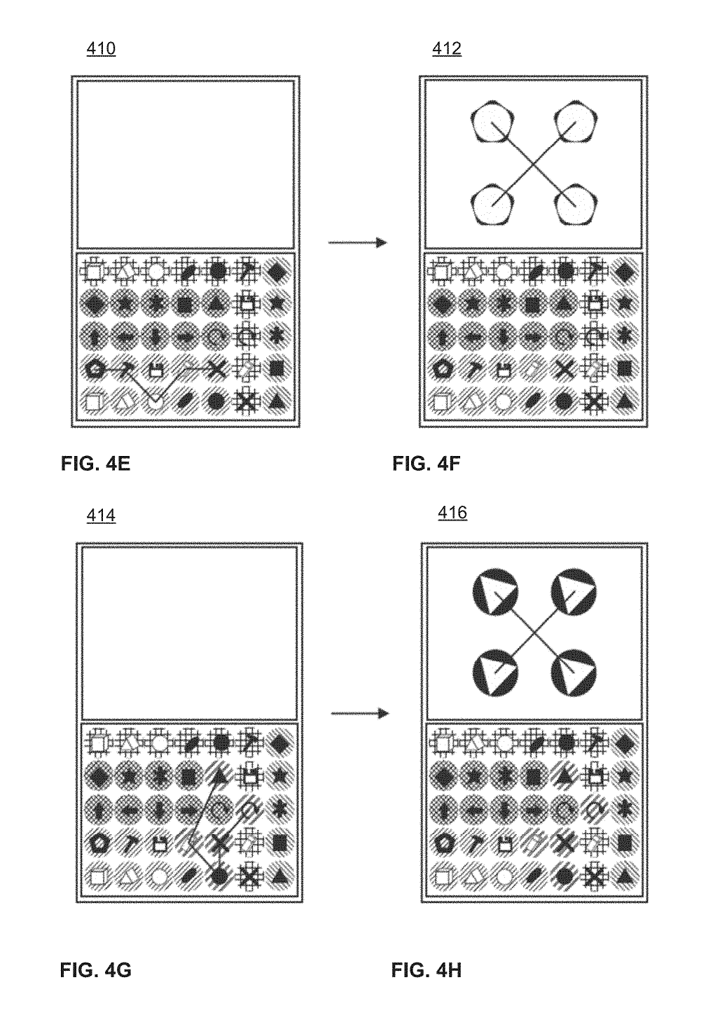

FIGS. 4A-4H depict few embodiments of applicable control element layouts and possible but merely exemplary user selections of multiple control elements applicable therein for triggering associated control actions in connection with the present invention.

In FIG. 4A, at 402 one merely exemplary control layout is shown with a matrix type, substantially rectangular (five rows, six columns, but there could also be equal number of rows and columns) structure of graphical control elements exhibiting different geometrical features including star, square, diamond/check, asterisk, triangle, circular and elliptical shapes. Such distinguishing features may imply different underlying control actions the elements have been associated with if included in a user selection as discussed hereinearlier.

In the shown embodiments, the second on-screen area comprising the structure of control elements has been positioned at the bottom of a display arrangement of one or more adjacent displays, whereas the first area for rendering the user-controlled object(s) has been positioned at the top, but a person skilled in the art shall acknowledge the fact that in other embodiments, the mutual configuration of the screen areas could be reversed or based on horizontal separation instead of vertical one, or be something more radically different.

In FIG. 4B, at 404 a sketch of a graphical object is shown in the first screen area and the second area again contains a control layout, which this time exhibits more complex ‘tool’ and directional control (arrow) shapes as well as different control elements grouped together having regard to their position and preferably also underlying similar or same category (sub-)function or contribution to the control action as discussed above. Each group of control elements has been allocated distinctive, preferably exclusive, visual feature such as background shading or graphical pattern adopted by the group members or e.g. their background area to facilitate their inspection and selection.

In FIGS. 4C and 4D a user selection of multiple control elements and related responsive control action are represented. The selection is indicated by a multi-segment line covering the selected elements. Such indication could be optionally shown to the user e.g. as a confirmation of a detected selection. The selection pattern is in this example based on five control elements indicated by a user through a swipe action, for example, upon the touchscreen. The control action causes a graphical object, or depending on the viewpoint four graphical objects, to show up in the upper, first on-screen area in accordance with the user selection and control data associating the user selection with control action.

At 410 and 412 of FIGS. 4E and 4F as well as at 414 and 416 of FIGS. 4G and 4H, respectively, two further examples are shown. However, in these examples the graphical control elements that may be selected at a time by a user to establish a meaningful selection, i.e. a detectable user selection associated with a control action, have been provided with a common visually distinguishable feature, in this particular example essentially being a background pattern, basically striping, whereas in the previous embodiments the common visual features among the members of a control element group were merely used to indicate spatial closeness or functional similarity in terms of the resulting control action or their contribution thereto.

Thereby in the context of FIGS. 4E-4H, control element groups inside which a valid user selection of multiple elements may be made at a time may be indicated via the common visual features of the group members or of underlying background, for example.

When a user tries assign control elements, which are not members of the same control element group as indicated by the visual features, to a common selection, there may thus be no control action of the graphical object associated with such group-crossing touch action/selection of control elements at all.

In some embodiments, as shown at 414 and 416 in FIGS. 4G and 4H, the executing device may be configured to detect and allow, in terms of providing a responsive meaningful control action, a touch action-based definition of a user selection of multiple control elements even though the touch action itself, potentially accidentally or purposefully (in case the user is e.g. well experienced with the UI and related control input mechanism), crosses an area associated with a group of control members another than the group in which the majority of the touch action-indicated elements are members, or an area not unambiguously associated with any control element or a related group. In this type of a scenario, the executing device may be configured to filter out such anomaly from a resulting, otherwise valid user selection of multiple elements.

In the illustrated example at 414 and 416, the aforesaid anomalies are represented by right arrow and right side circular arrow carrying a grid type background pattern in the middle of the control element structure and/or the lengthened empty space around them which the touch action basically covers on its journey between two control elements with diagonal striping type background ending up in the final user selection of five striped elements.

One may also combine the above approaches flexibly depending on the embodiment.

For example, several control elements with similar or categorically similar contribution to the control action may by means of common visually distinguishable feature and optionally by common spatial positioning, grouped together.

Still, several control elements from within which a meaningful user selection may be made at a time may be indicated with some other common, preferably visually distinguishable feature.

These various visual or spatial features of control elements having different implications may overlap, i.e. a single control element may exhibit both an action-related grouping and user selection (validity) -related grouping by means of related visually distinguishable features and/or spatial positioning of the element.

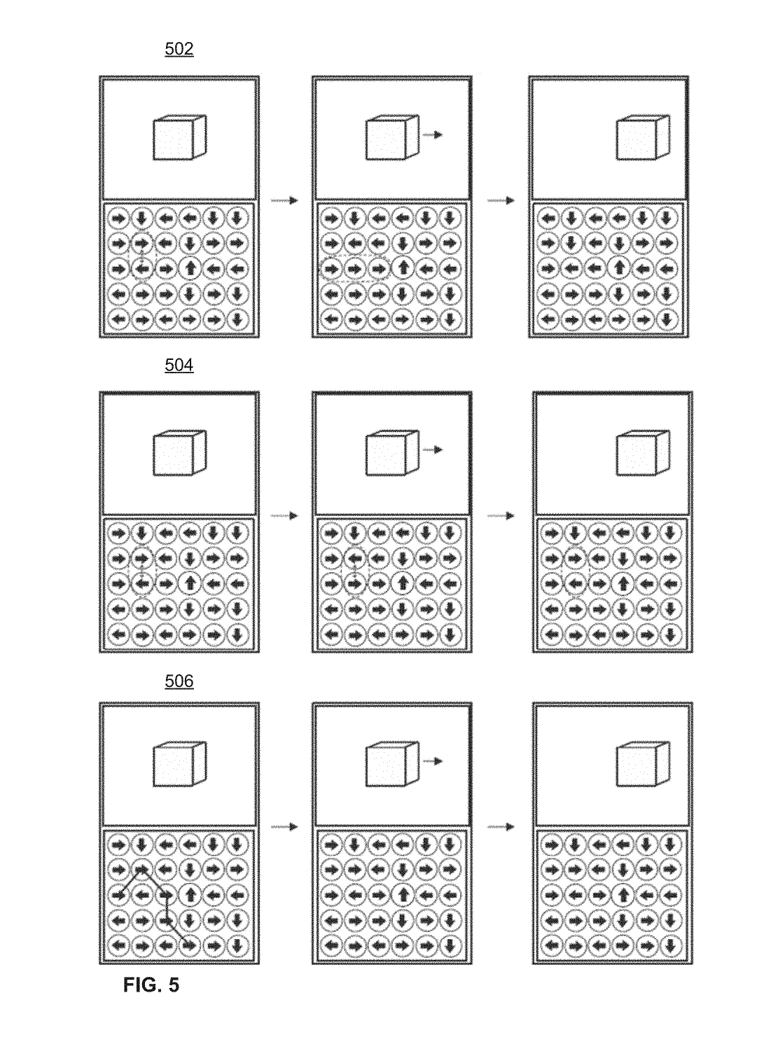

FIG. 5 still depicts further embodiments of possible control element layouts, related user selections and control actions having regard to a graphical object such as game character or generally game object controlled.

In contrast to the embodiments of FIGS. 4B-4H, all the control elements are generally of similar, circular shape and exhibit a single visually distinguishable feature only, in this case being directional arrow pointing at some orthogonal (up, down, left, right) direction. One may now recall that FIG. 4A already illustrated a bit similar construction of control elements but with different visual features.

Therefore, in the present and also in the previously discussed scenario of FIG. 4A a single visual feature (arrow) may be indicative of both the underlying control action in case the concerned control element is included in a user selection, and a valid selection group from within which a control action resulting user selection may be made at a time in contrast to e.g. group crossing selections of control elements.

At 502, a scenario is shown in which the control elements include directional arrow shapes. These features indicate the underlying control action if multiple, in the shown example three, similar elements are members of a user selection.

In the leftmost sketch, as swap action is illustrated in terms of two control elements exhibiting left and right arrows and thus indicating movement type control action of the graphical object in such direction when combined with at least two similar elements in a user selection.

The user indeed swipes the upper (right side) arrow by a touch action to the center row (i.e. the two control elements switch places) to establish a line shaped user selection of three right arrows, which is shown in the next sketch in the middle.

The user selection is detected by the executing device and verified (i.e. the selection is considered valid according to predefined criteria and/or is associated with a control action), which can be signalled to the user via a visual effect such as color effect and/or animation, and/or by a connecting element between the selected elements.

The user selection of three right arrows has been associated, by the control data, with a control action moving the controlled graphical object, e.g. a game character or object such as a vehicle, to the right as shown in the last, rightmost sketch.

In the shown embodiment, the user selection is then deleted from the structure and the elements above move downwards to take their position. The resulting empty slots of the top row gain three new control elements, which may be selected based on random, pseudo-random or some other type of logic, for example, by the executing device.

Alternatively, the swapped elements could ultimately regain their original positions. The elements of the user selection are not deleted from the structure. This is shown at 504.

At 506, the user selection is of more complex shape and comprises five elements with right side arrows. The selection is not deleted upon executing the associated control response.

Depending on the embodiment, the user may immediately re-select the same elements for the next control action.

The number of similar or identical elements in a user selection may convert into magnitude control of the related control action, i.e. a greater number of similar elements such as ‘right side’ arrow elements selected is translated into increased movement of the controlled graphical object e.g. to the right.

Depending on the embodiment with reference to also other embodiments than the ones of FIG. 5, there may be defined a minimum number of elements in a valid user selection.

Yet, there may be defined a minimum number of similar, e.g. identical, elements in a valid user selection.

In some embodiments, also the resulting continuous pattern may take a number of allowed shapes only, whereupon not all user selections of connected, otherwise valid, control elements are ultimately allowed by the device for triggering a control action.

The scope of the present invention is determined by the attached claims together with the equivalents thereof.

A person skilled in the art will appreciate the fact that the disclosed embodiments were constructed for illustrative purposes only, and further implementations of the arrangements and methods applying many of the above principles could be readily prepared to better suit each potential use scenario.

1. An electronic device comprising a touchscreen, data storage and a processor operatively connected to the touchscreen and the data storage, configured to:
display a first on-screen area for accommodating one or more user-controllable graphical objects, such as game characters or other graphical objects,
display, simultaneously with the first on-screen area, a second on-screen area preferably substantially adjacent to, optionally below or above, the first on-screen area, said second on-screen area being provided with a preferably symmetrical at least two-dimensional structure, such as a matrix, of a plurality of graphical control elements, optionally icons, which are user-selectable by touch,
detect a touch action-based, preferably swipe action based, user selection of multiple, preferably at least three, control elements of said plurality, wherein the selected control elements define a continuous pattern in vertical, horizontal and/or diagonal direction within the structure, and further wherein the touch action extends over at least two control elements depicted in the second on-screen area at least one of which being a member of the pattern of the selected elements,
determine a control action for at least one user-controllable object in the first on-screen area responsive to the detected user selection and stored control data associating a number of selections of multiple control elements with control actions, including an association of the detected user selection with the determined control action, and
execute the control action regarding said least one object in the first on-screen area according to the determination.

2. The device of claim 1, configured to detect the user selection based on a touch action extending over two orthogonally or diagonally adjacent control elements defining at least temporary location swap therebetween and thereby resulting in a formation of the user selection comprising one of the swapped elements.

3. The device of claim 1, wherein a selectable control element incorporates a visually distinguishable feature, optionally a symbol or shape, preferably indicative of the control action associated with a user selection including such control element.

4. The device of claim 1, wherein the detected user selection comprises at least one structural feature selected from the group consisting of: orthogonal portion of two or more adjacent control elements, horizontal portion of two or more adjacent control elements, vertical portion of two or more adjacent control elements, and diagonal portion of two or more adjacent control elements.

5. The device of claim 1, wherein the elements defining a detectable user selection associated with a control action are rendered visually identical or incorporate at least a common visually distinguishable feature, the appearance of the elements being preferably indicative of the control action associated therewith.

6. The device of claim 1, configured to convert an increase in the number of identical or similar control elements in a user selection into an increase in the magnitude of a resulting control action associated with such selection, optionally movement of a rendered graphical object.

7. The device of claim 1, wherein the control action is dependent on at least one feature of the user selection selected from the group consisting of: number of control elements included, type of control elements included, and shape of the pattern defined by the selection.

8. The device of claim 1, wherein the control action comprises at least one element selected from the group consisting of: movement of a user-controllable graphical object, orthogonal movement of a user-controllable graphical object, vertical movement of a user-controllable graphical object, horizontal movement of a user-controllable graphical object, movement of a user-controllable graphical object where the amount of movement depends on the number of movement-associated elements in the user selection, acceleration or deceleration of a controllable graphical object, increase in the size or zooming in a graphical object, decrease in the size or zooming out a graphical object, deletion of a feature of a graphical object, addition of a feature in a graphical object, change of a color or a graphical pattern of a graphical object, making and rendering a copy of a graphical object, back and forth type movement such as jump of a graphical object, emission of a feature such as a projectile from a graphical object, and rotation of a graphical object.

9. The device of claim 1, configured, subsequent to a detection of the user selection and optionally determination and execution of associated control action, to execute at least one action selected from the group consisting of: render at least the control elements of the user selection in their original position prior to the touch action, delete the control elements of the user selection from the first on-screen area, and replace the control elements of the user selection from the first on-screen area with other control elements, the other control elements being either new control elements or existing adjacent control elements that are shifted to the locations of the control elements of the user selection optionally in orthogonal such as vertical or particularly top-to-bottom direction preferably so that the remaining elements behind the originally shifted ones are also shifted to the spaces otherwise left empty and further preferably so that the resulting empty border areas are introduced with new control elements.

10. The device of claim 1, configured to at least visually confirm the detected selection to a user through graphically highlighting the elements of the selection, optionally rendering a connecting element such as a line between and/or upon the elements of the selection or providing the elements of the selection with some other common visual feature, such as color feature, distinguishing them from the other elements.

11. A method for receiving control input at an electronic device comprising a touchscreen, a data storage and a processor operatively connected to the data storage and the touchscreen, said method comprising:
displaying a first on-screen area for accommodating one or more user-controllable graphical objects, such as game characters or other graphical objects,
displaying, simultaneously with the first on-screen area, a second on-screen area preferably substantially adjacent to, optionally below or above, the first on-screen area, said second on-screen area being provided with a preferably symmetrical at least two-dimensional structure, such as a matrix, of a plurality of graphical control elements, optionally icons, which are user-selectable by touch,
detecting a touch action-based, preferably swipe action based, user selection of multiple, preferably at least three, control elements of said plurality, wherein the selected elements define a continuous pattern in vertical, horizontal and/or diagonal direction within the structure, and further wherein the touch action extends over at least two control elements depicted in the second on-screen area at least one of which being a member of the pattern of the selected elements,
determining a control action for at least one user-controllable object in the first on-screen area responsive to the detected user selection and stored control data associating a number of selections of multiple control elements with control actions including an association of the detected user selection with the control action, and
executing the control action regarding said least one object in the first on-screen area according to the determination.

12. A computer program product embodied in a non-transitory carrier medium, comprising code means adapted, when run on a computer comprising a touchscreen, to cause:
displaying a first on-screen area for accommodating one or more user-controllable graphical objects, such as game characters or other graphical objects,
displaying, simultaneously with the first on-screen area, a second on-screen area preferably substantially adjacent to, optionally below or above, the first on-screen area, said second on-screen area being provided with a preferably symmetrical at least two-dimensional structure, such as a matrix, of a plurality of graphical control elements, optionally icons, which are user-selectable by touch,
detecting a touch action-based, preferably swipe action based, user selection of multiple, preferably at least three, control elements of said plurality, wherein the selected elements define a continuous pattern in vertical, horizontal and/or diagonal direction within the structure, and further wherein the touch action extends over at least two control elements depicted in the second on-screen area at least one of which being a member of the pattern of the selected elements,
determining a control action for at least one user-controllable object in the first on-screen area responsive to the detected user selection and stored control data associating a number of selections of multiple control elements with control actions including an association of the detected user selection with the control action, and
executing the control action regarding said least one object in the first on-screen area according to the determination.

13. (canceled)
